(19) United States
(12) Patent Application Publication
(10) Pub. No.: US 2022/0205873 A1
(43) Pub. Date: Jun. 30, 2022

(54) TEST MACHINE FOR VEHICLE WHEEL

(71) Applicant: TEST INDUSTRY S.R.L., Milano (IT)

(72) Inventor: Daniel SPEZZABALLI, Milano (IT)

(21) Appl. No.: 17/605,420

(22) PCT Filed: May 21, 2020
(86) PCT No.: PCT/IB2020/054822

§ 371 Date: Oct. 21, 2021

(30) Foreign Application Priority Data
May 23, 2019 (IT) 102019000007172

(51) Int. Cl. G01M 17/02

(52) U.S. Cl. CPC G01M 17/022; G01M 17/021

(57) ABSTRACT

A testing machine for a vehicle wheel includes a base frame, and a drum rotatably supported by the base frame around a drum axis. The testing machine has a drum actuator, for rotating the drum around the drum axis. A wheel movement device rotatably supports the vehicle wheel around a wheel axis and moves the vehicle wheel from a position spaced from the drum to a position in contact with the drum. The base frame rotatably supports the wheel movement device around a slip rotation axis, incident or perpendicular to a plane tangent to the contact point between the vehicle wheel and the drum. The base frame rotatably supports the wheel movement device around a camber rotation axis, perpendicular to the wheel and slip rotation axe. Following rotation of the wheel movement device around the camber rotation axis, the vehicle wheel is rotated according to a camber angle.

The present invention relates to a testing machine for a vehicle wheel, such as for example a wheel of a light or heavy vehicle, for example a car or a truck or an agricultural vehicle.

Testing machines are known in the art, i.e. machines for simulating loads to which a vehicle suspension system is subjected totally or partially during normal or extreme use. This type of testing machine generally consists of a rotating drum on which the complete wheel of a vehicle (i.e. the rim and tire assembly) is positioned in contact. The wheel is then subjected to a series of dynamic stresses by the testing machine in one or more predefined cycles, so as to try to simulate the behavior of the wheel on the road.

In particular, the testing machines of the prior art are able to control and measure the forces and moments acting on the wheel, when the latter is subjected to the three typical movements of this type of machine, that is, a linear radial movement, an angular slip movement and an angular camber movement.

In order to carry out the movements described above, the testing machines of the prior art employ bulky and heavy structures. This is due to the need to ensure adequate support for the loads involved and to prevent unwanted vibrations from triggering.

Unfortunately, the bulky and heavy structures of the machines of the prior art involve high inertias which affect the accelerations, speeds and precision of the movements obtainable from the testing machine.

Furthermore, the bulky structures of the machines of the prior art require the use of actuators of great power, and therefore of high weight, bulk, as well as requiring high energy resources.

One of the objects of the present invention is to propose a testing machine for a vehicle wheel capable of overcoming the drawbacks of the prior art testing machines. In particular, one of the objects of the present invention is to provide a testing machine for a vehicle wheel which has reduced weight and dimensions and at the same time is able to more faithfully reproduce the dynamic features of the actual stresses to which a wheel is subject on a road or in extreme road conditions.

This object is achieved with a testing machine for a vehicle wheel according to the appended independent claim. The dependent claims describe preferred or advantageous embodiments of the testing machine for a vehicle wheel.

The features and the advantages of the testing machine for a vehicle wheel according to the invention shall be made readily apparent from the following description of preferred embodiments thereof, provided purely by way of a non-limiting example, with reference to the accompanying figures, in which:

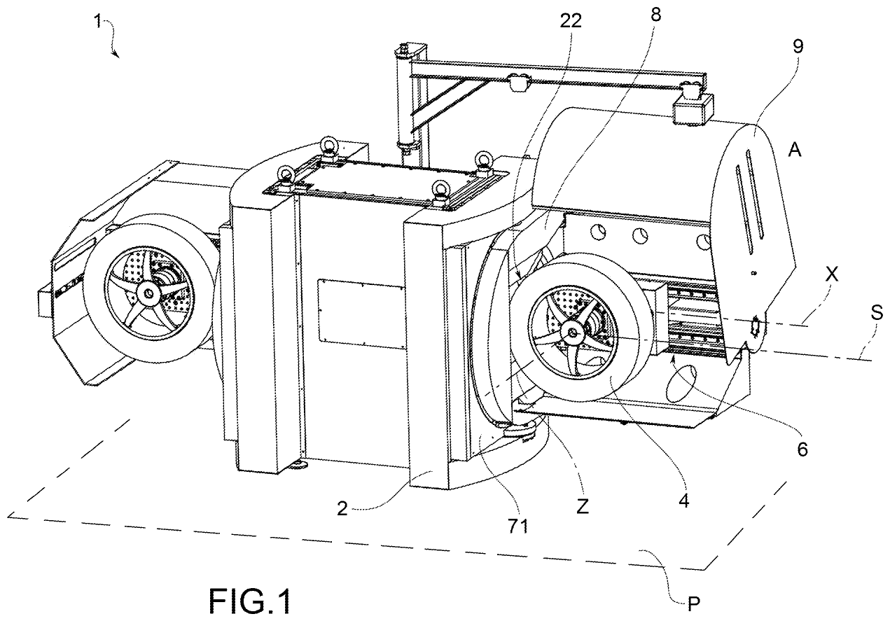

FIG. 1 shows an overall view of the testing machine according to an embodiment of the present invention, with a wheel protection device in the open configuration;

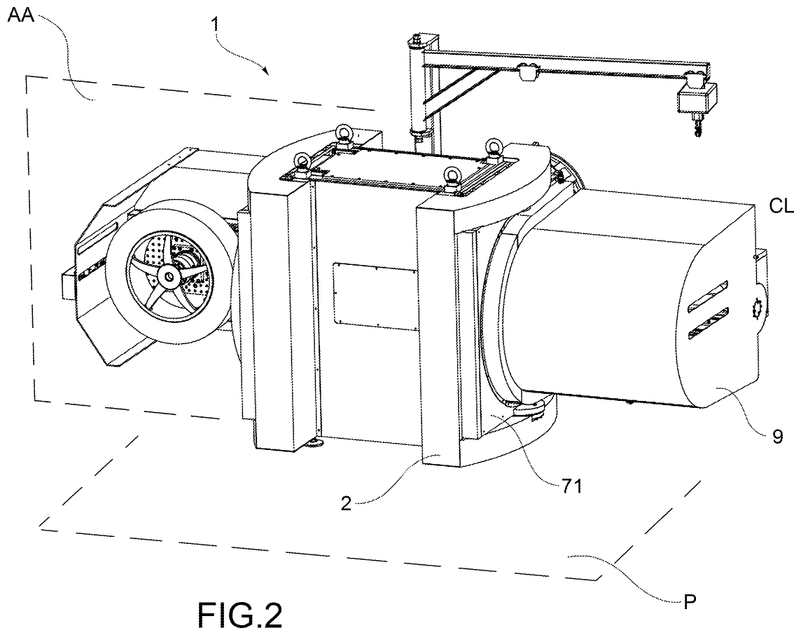

FIG. 2 shows an overall view of the testing machine according to an embodiment of the present invention, with the wheel protection device in the closed configuration;

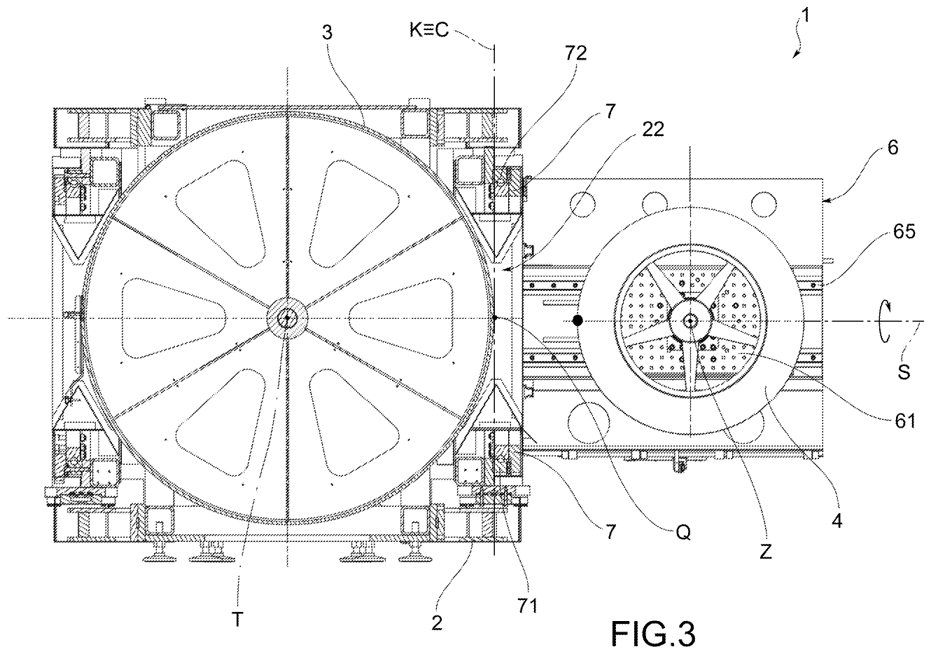

FIG. 3 shows a partial vertical sectional view of the testing machine along the plane AA of FIG. 2, in which the vehicle wheel is spaced apart from the rotating drum;

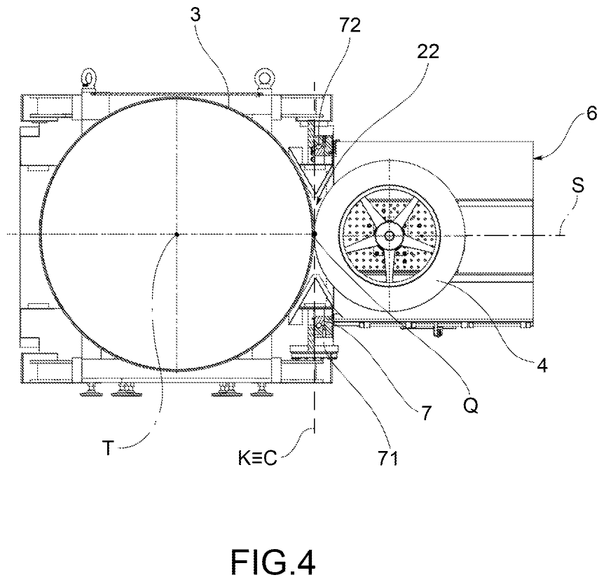

FIG. 4 shows a partial vertical sectional view of the testing machine along the plane AA of FIG. 2, in which the vehicle wheel is in contact with the rotating drum;

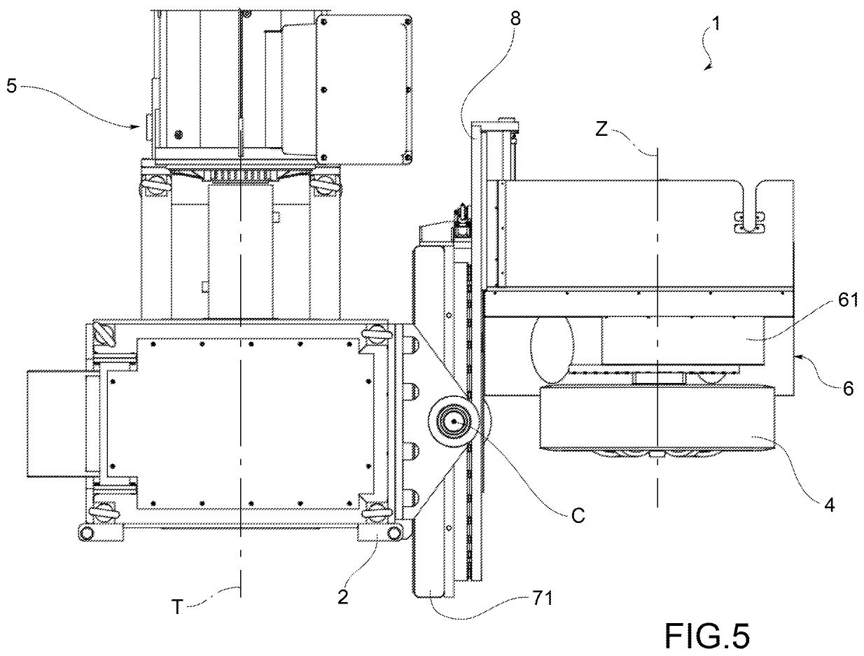

FIG. 5 shows a partial top plan view of the testing machine of FIG. 1;

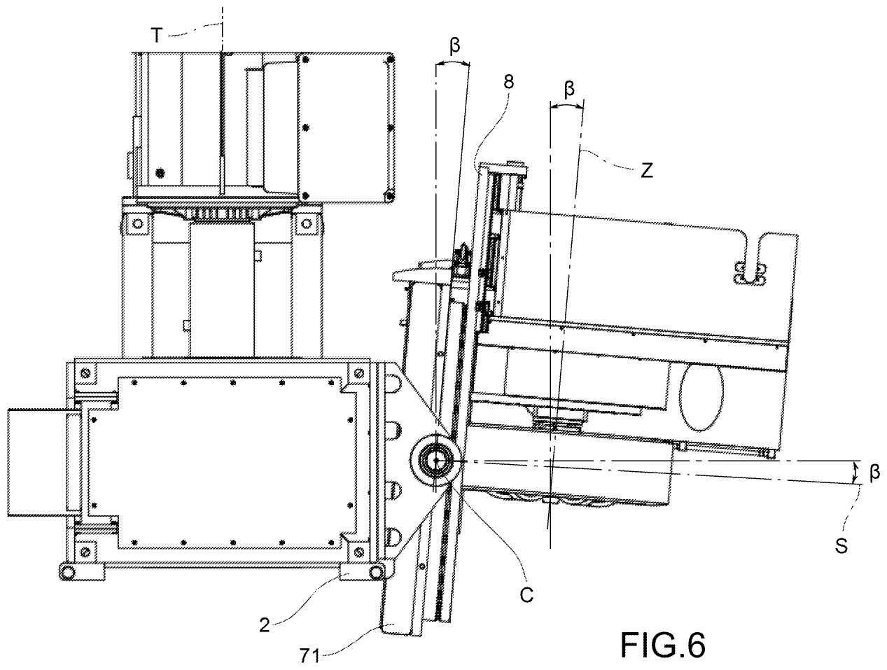

FIG. 6 shows a partial top plan view of the testing machine of FIG. 1, in which the vehicle wheel has undergone a rotation around the camber axis C by a camber angle β with respect to FIG. 5;

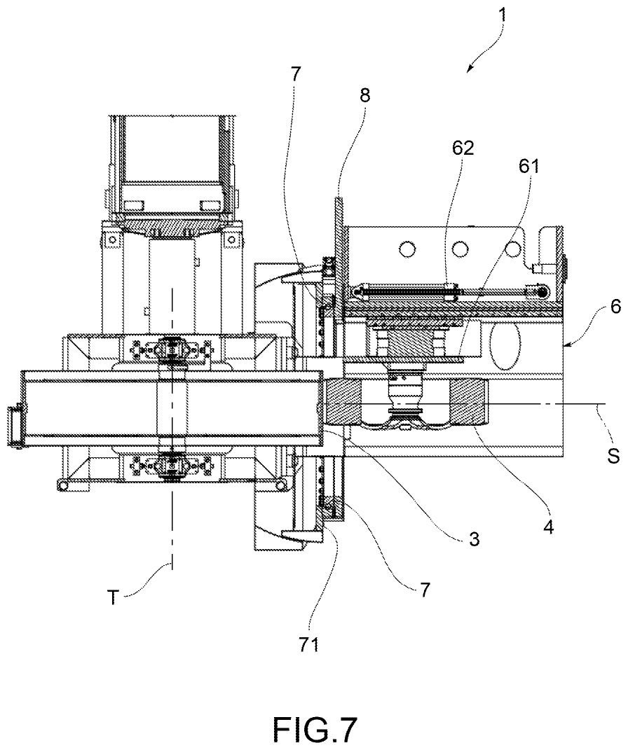

FIG. 7 shows a sectional view along a horizontal sectional plane of the testing machine of FIG. 2;

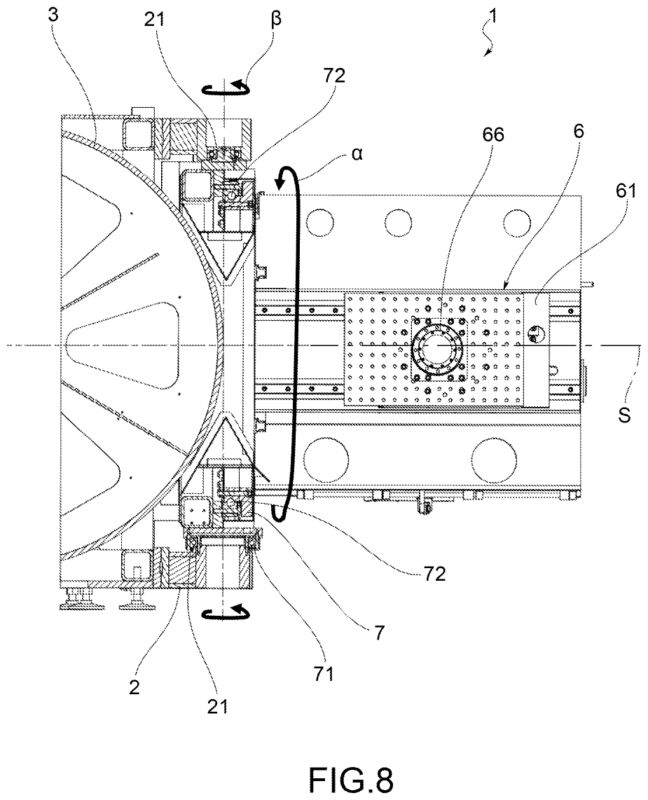

FIG. 8 shows a vertical sectional detail of the testing machine, in which the vehicle wheel has been removed;

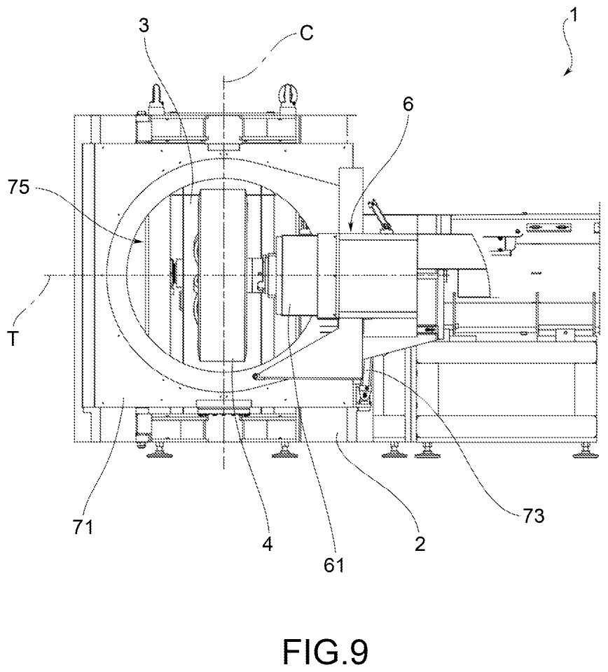

FIG. 9 shows a side elevation view of the testing machine of FIG. 1;

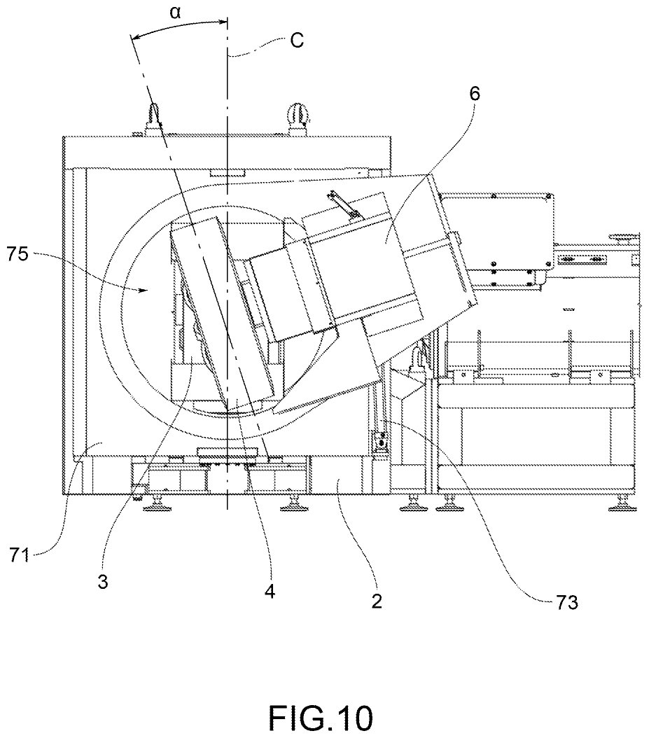

FIG. 10 shows a side elevation view of the testing machine of FIG. 1, in which the vehicle wheel has undergone a rotation around the slip rotation axis S by a lateral slip angle α with respect to FIG. 10.

With reference to the aforesaid figures, the reference numeral 1 generally indicates a testing machine 1 for a vehicle wheel 4. In particular, a testing machine suitable for subjecting a vehicle wheel 4 to dynamic stresses, which simulate dynamic stresses under normal use of the wheel 4 on a vehicle.

The testing machine 1 comprises a base frame 2, suitable for resting on a support surface P, and a rotating drum 3 rotatably supported by the base frame 2 around a rotating drum axis T. The base frame 2 is for example a container suitable for containing the rotating drum 3. Preferably, the base frame 2 comprises an access window 22 to the rotating drum 3, so that the vehicle wheel 4 may come into contact with the rotating drum 3 through the access window 22.

The testing machine 1 further comprises rotating drum actuating means 5, for the rotation of the rotating drum 3 around the drum axis T, for example an electric or hydraulic motor.

Furthermore, the testing machine 1 comprises a wheel movement device 6, suitable for rotatably supporting the vehicle wheel 4 around a wheel axis Z. Moreover, the wheel movement device 6 is suitable for moving the vehicle wheel 4 from a position spaced from the rotating drum 3 to a position in contact with the rotating drum 3.

Preferably, the wheel movement device 6 is arranged in front of the access window 22 and protrudes from the base frame 2 in a horizontal direction X, parallel to the support surface P.

The wheel movement device 6 is rotatably supported by the base frame 2 around a slip rotation axis S, said slip rotation axis S being incident or perpendicular to a plane K tangent to the contact point Q between the vehicle wheel 4 and the rotating drum 3. In this way, following a rotation of the wheel movement device 6 around the slip rotation axis S, the vehicle wheel 4 is rotated according to a lateral slip angle α (or slip angle).

Moreover, the wheel movement device 6 is rotatably supported by the base frame 2 around a camber rotation axis C. The camber rotation axis C is perpendicular to the wheel axis Z and to the slip rotation axis S, so that following a rotation of the wheel movement device 6 around the camber rotation axis C, the vehicle wheel 4 is rotated according to a camber angle R.

According to a preferred embodiment, the slip rotation axis S and the camber rotation axis C are incident at the point of contact Q between the vehicle wheel 4 and the rotating drum 3.

Preferably, the wheel movement device 6 comprises a carriage 61 suitable for rotatably supporting the vehicle wheel 4 around the wheel axis Z. The carriage 61 is movable along the horizontal direction X parallel to the slip rotation axis S, for example perpendicular to the wheel axis Z. Preferably, the carriage 61 is movable along a guide 65, arranged in the horizontal direction X.

In particular, the carriage 61 comprises a hub 66 on which it is possible to rotatably constrain the vehicle wheel 4, so that the vehicle wheel 4 may turn idly.

Preferably, the testing machine 1 comprises a slewing ring 7 and a slewing ring support frame 71. The slewing ring 7 is rotatably supported by the slewing ring support frame 71 around the slip rotation axis S.

Preferably, the slewing ring 7 comprises a central cavity 75, suitable for being crossed by the vehicle wheel 4 when the vehicle wheel is placed in contact with the rotating drum 3. In other words, the slewing ring 7 is placed in the proximity and around the point of contact Q between the vehicle wheel 4 and the rotating drum 3.

Preferably, therefore, the slewing ring 7 rotates on a slewing ring plane parallel to or substantially coplanar with the plane that defines the access window 22.

Furthermore, preferably, the slewing ring 7 is arranged all around the access window 22.

Preferably, the testing machine 1 comprises a carriage support 8 which supports the carriage 61 and which is constrained to the slewing ring 7 so as to be integral in rotation with the slewing ring 7. In this way, when the slewing ring is rotated around the slip rotation axis S, the entire wheel movement device 6 follows the rotation.

Preferably, the slewing ring support frame 71 is rotatably supported by the base frame 2 around the camber rotation axis C. In this way, when the slewing ring support frame 71 is rotated around the camber rotation axis C, the entire wheel movement device 6 and the slewing ring 7 also follow the rotation.

Preferably, between the slewing ring 7 and the slewing ring support frame 71 and between the slewing ring support frame 71 and the base frame 2, ball bearings 72, 21 are provided.

Preferably, each rotation around the camber rotation axis C and around the slip rotation axis S is actuated by an independent actuator.

In particular, the testing machine 1 comprises a slewing ring movement actuator 73, for example a pneumatic or hydraulic cylinder, operatively connected to the slewing ring 7 to cause the rotation of the slewing ring 7, a carriage actuator 62, for example a pneumatic or hydraulic cylinder, operatively connected to the carriage 61 to cause the translation of the carriage 62 and a slewing ring support actuator, for example a pneumatic or hydraulic cylinder, operatively connected with the slewing ring support frame 71 to cause the rotation of the slewing ring support frame 71 around the camber rotation axis C.

In a particularly advantageous embodiment, the wheel movement device 6 is suspended, i.e. entirely suspended, with respect to the support surface P. In particular, the wheel movement device 6 is totally supported by the slewing ring 7, by means of the carriage support 8.

Preferably, as shown in the accompanying figures, the wheel movement device 6 is arranged entirely on one side of the slewing ring surface or in any case on one side of the surface which defines and passes through the access window 22. This allows compact size and simplicity of construction to be obtained.

In an embodiment variant, the wheel movement device comprises a wheel protection device 9. Such a wheel protection device 9 may be moved from an open configuration A, in which the wheel protection device 9 allows access to the wheel movement device 6 for the insertion of a vehicle wheel 4, to a closed configuration CL, in which the wheel protection device 9 wraps the wheel 4. In this closed configuration CL, during the test (i.e. operation of the machine with the wheel in contact with the rotating drum 3, the wheel protection device 9 blocks any residual material or fumes coming from the wheel, so as to prevent the diffusion thereof in the surrounding environment. Furthermore, the wheel movement device is also capable of blocking an accidental release of the wheel from the carriage 61.

In a preferred embodiment, shown in FIGS. 1 and 2, the wheel protection device 9 is a frame, rotatably constrained to the wheel movement device 6 around an axis parallel to the horizontal axis X, for moving the wheel protection device from the open configuration A to the closed configuration CL. Preferably, such a wheel protection device 9 is therefore a shell which wraps the wheel in a spaced manner.

Innovatively, the testing machine according to the present invention allows solving the drawbacks related to the prior art. In particular, the configuration of the testing machine according to the present invention allows decreasing the flexures and dynamic actions acting on the entire structure of the machine, allowing a lighter and at the same time more rigid machine to be obtained compared to the machines of the prior art.

Thanks to this, it is possible to simulate test dynamics at higher frequencies than the prior art, while keeping the testing machine with a simple structure and with a relatively limited use of resources.

Moreover, advantageously, the testing machine according to the present invention is more compact and less bulky.

In particular, by virtue of the presence of the slewing ring 7, located in the vicinity of the access window 22 and at the camber rotation axis C, the testing machine 1 is extremely compact in size compared to the dimensions of the machines of the prior art.

Furthermore, advantageously, the presence of a wheel protection device allows easily and effectively blocking any rubber residues and brake dust generated during the tests.

Furthermore, by virtue of the presence of a wheel movement device suspended with respect to the support surface, it is possible to have simple and effective access to the wheel, thus facilitating wheel change and cleaning operations.

A man skilled in the art may make several changes or replacements of elements with other functionally equivalent ones to the embodiments of the testing machine in order to meet specific needs.

Also, such variants are included within the scope of protection as defined by the following claims.

1. Testing machine for a vehicle wheel comprising:
a base frame for resting on a support surface;
a rotating drum rotatably supported by the base frame around a drum axis;
a rotating drum actuator, for rotation of the rotating drum around the drum axis;
a wheel movement device for rotatably supporting the vehicle wheel around a wheel axis and for moving the vehicle wheel from a position spaced from the rotating drum to a position in contact with the rotating drum;
wherein the wheel movement device is rotatably supported by the base frame around a slip rotation axis, said slip rotation axis being incident or perpendicular to a plane tangent to a contact point between the vehicle wheel and the rotating drum so that following a rotation of the wheel movement device around the slip rotation axis, the vehicle wheel is rotated according to a lateral slip angle;
and wherein the wheel movement device is rotatably supported by the base frame around a camber rotation axis, said camber rotation axis being perpendicular to the wheel axis and to the slip rotation axis, so that following a rotation of the wheel movement device around the camber rotation axis, the vehicle wheel is rotated according to a camber angle.

2. Testing machine according to claim 1, wherein the slip rotation axis and the camber rotation axis are incident at the contact point between the vehicle wheel and the rotating drum.

3. Testing machine according to claim 1, wherein the wheel movement device comprises a carriage for rotatably supporting the vehicle wheel around the wheel axis, said carriage being movable along a horizontal direction parallel to the slip rotation axis.

4. Testing machine according to claim 1, comprising a slewing ring and a slewing ring support frame, wherein said slewing ring is rotatably supported by the slewing ring support frame around the slip rotation axis.

5. Testing machine according to claim 4, wherein the slewing ring is placed proximate and around the contact point between the vehicle wheel and the rotating drum.

6. Testing machine according to claim 3, comprising a carriage support which supports the carriage, and which is constrained to the slewing ring to be integral in rotation with the slewing ring.

7. Testing machine according to claim 4, wherein the slewing ring support frame is rotatably supported by the base frame around the camber rotation axis.

8. Testing machine according to claim 4, further comprising ball bearings between the slewing ring and the slewing ring support frame and between the slewing ring support frame and the base frame.

9. Testing machine according to claim 3, comprising a slewing ring movement actuator, operatively connected to the slewing ring to cause the rotation of the slewing ring, a carriage actuator, operatively connected to the carriage to cause the translation of the carriage and a slewing ring support actuator, operatively connected with the slewing ring support frame to cause rotation of the slewing ring support frame.

10. Testing machine according to claim 3, wherein the wheel movement device is suspended with respect to the support surface.

11. Testing machine according to claim 10, wherein the wheel movement device is supported solely by the slewing ring, by the carriage support.

12. Testing machine according to claim 1, wherein the wheel movement device comprises a wheel protection device, which is movable from an open configuration, in which the wheel protection device allows access to the wheel movement device for insertion of a vehicle wheel to a closed configuration, in which the wheel protection device winds the wheel so that, during testing, the wheel protection device blocks residues of material or fumes coming from the wheel.

13. Testing machine according to claim 12, wherein the wheel protection device is a frame, rotatably constrained to the wheel movement device around an axis parallel to the horizontal axis, for moving the wheel protection device from the open configuration to the closed configuration.

14. Testing machine according to claim 9, wherein the slewing ring movement actuator comprises a pneumatic or hydraulic cylinder, and wherein the carriage actuator comprises a pneumatic or hydraulic cylinder, and wherein the slewing ring support actuator comprises a pneumatic or hydraulic cylinder.
